(19) United States
(12) Patent Application Publication
(10) Pub. No.: US 2015/0093667 A1
(43) Pub. Date: Apr. 2, 2015

(54) VERIFICATION OF REPLACEABLE FUEL CARTRIDGES FOR FUEL CELL POWER SYSTEMS

(71) Applicant: INTELLIGENT ENERGY LIMITED, LOUGHBOROUGH (GB)

(72) Inventors: Philip Mitchell, Loughborough (GB); Anand Chellappa, Long Beach, CA (US)

(21) Appl. No.: 14/380,686

(22) PCT Filed: Jan. 18, 2013
(86) PCT No.: PCT/US13/22160

§ 371 Date: Aug. 22, 2014

Related U.S. Application Data
(60) Provisional application No. 61/590,627, filed on Jan. 25, 2012.

(51) Int. Cl. H01M 8/04; G06F 17/30

(52) U.S. Cl. CPC H01M 8/04223; G06F 17/30386; G06F 17/30345; H01M 8/04089
USPC 429/429; 707/758; 707/609

(57) ABSTRACT

A hydrogen cartridge with a dispensing end, said cartridge having unique identification associated therewith is disclosed, said cartridge providing a supply of hydrogen and being removably fitted to a host device. Prior to use in said host device, the unique identifier is input into a communications device which, through a network, contacts a secure database with records of authentic unique identifiers. Said secure database may require verification of a user and/or a communication device prior to granting access. The host device also has a communications link whereby one of the database and the communications device may provide authorization to a host device, including but not limited to a controller, to utilize the hydrogen in the canister associated with a specific unique identifier.

### RELATED APPLICATION

This application claims the full Paris Convention benefit of and priority to U.S. provisional application 61/590,627, filed Jan. 25, 2012, the contents of which are incorporated by this reference, as if fully set forth herein.

### BACKGROUND

1. Field

This disclosure relates to fuel cell power systems, fuel cartridges to support such systems, and methods for supplying and authenticating fuel cartridges for use in fuel cell powered systems.

2. General Background

World-wide commercial use of fuel cell powered host devices, particularly portable devices. A non-exclusive list of potential host devices include, but are not limited to, computer peripherals, mobile phone peripherals, mobile phones, personal music players, laptops, notebooks, tablet, gaming devices, personal digital assistants (PDAs), and battery chargers. A fuel cell power system can either be located inside the host device or can be connected to the host device using suitable means. In either case, a means to provide fuel to the power system is required. An example of one such means is the use of fuels packaged in cartridges (packaged fuel) in predetermined amounts to satisfy the volume, weight and run time requirements of the host device, use profile of the host device, and regulatory requirements associated with the host device. For the sake of simplicity, a fuel cell power system is considered to comprise of a fuel cell subsystem that includes the fuel cell or a multiplicity of fuel cells in the form of a fuel cell stack, fluid, and power management means, a process controller, and the fuel cartridge. The fuel cartridge is connected to the fuel cell subsystem system using a connector or coupling.

To support commercialization, low-cost, user-friendly, methods for authentication, and methods for monitoring the status and health of the fuel cell power system, and logistics associated with supply and disposing of fuel cartridges are needed. At the other end of the spectrum of low-cost are cartridges such as those disclosed in U.S. Pat. Nos. 7,655,331, 7,401,712, 7,306,863, 6,828,049 and 7,9149,45 which require memory components and other identification tags to enable this bi-directional communication. One may expect higher unit costs for such devices, and part of the costs in recycling of spent cartridges may include expensive components to be harvested.

Accordingly it is a desideratum to have an alternative to “smart” cartridges to enable user-friendly and low-cost fuel cartridges and fuel cell power systems, and methods that enable authentication of fuel cartridges for use in fuel cell power systems.

### DESCRIPTION

According to some exemplary implementations a method, system and device for authenticating replaceable hydrogen cartridges in a host system utilizing at least a fuel cell to generate electricity.

According to some exemplary implementations a method, system and device for verifying authenticity of a replaceable hydrogen canister's authenticity for use in a host system utilizing at least a fuel cell to generate electricity including at least one unique identifier element (UIE) associated with a fuel canister used to verify the canister. A user inputs the UIE into a user's communication device (remote from said host); said communications device checks a database to determine if the canister associated with the UIE is authentic. In some instance said database reports authentication of the canister to the communication device for the user to observe. In other instances the communication device provides authorization, based on authentication, for a host device to utilize the canister and its contents. The communications device may also be the host device. Optionally, the host may be the communications system.

According to some exemplary implementations a method, system and device for verifying authenticity of a replaceable hydrogen canister's authenticity for use in a host system utilizing at least a fuel cell to generate electricity including at least one UIE associated with a fuel canister used to verify the canister. A user inputs the UIE into a user's communication device; said communications device checks a database to determine if the canister associated with the UIE is authentic. The user may also input the identity of the host device and check the database to determine if the authenticated canister is compatible with the identified host. The communications device may also be the host device.

In some exemplary implementations devices for checking UIE or compatibility may be local on the communication device. Said database may be remote ad accessible through at least one of the internet or a cellular network.

In some exemplary implementations communications devices may include at least one of a smartphone, smart device, pad, tablet, laptop, and computer. In some instances the host is placing at least one unique placing at least one unique ed with said communication device and said communication device acts as a switch to authorize said host to utilize said fuel canister.

In some exemplary implementations the communications identifying the canister and/or host device is reported to a database to record the authorization and use of the fuel canister.

In some exemplary implementations the UIE is selected from the group considering of codes, colors, bar codes, numbers, letters, holograms, glyphs, images and icons.

In some exemplary implementations inputting is via keystrokes, scan, touch screen, optical imaging or voice command.

In some exemplary implementations disclosed is a hydrogen fuel cell power system for use as a power supply charger which may be connected to other devices or said fuel cell system may be integrated into another device.

For purposes of this disclosure a host device may be a fuel cell power system and balance of plant that accepts a replaceable hydrogen cartridge or canister. For purposes of this disclosure a host device may be a device which has a fuel cell power subsystem and balance of plant integrated therein that accepts a replaceable fuel cell canister.

In some exemplary implementations disclosed is a hydrogen cartridge with a dispensing end, said cartridge has a UIE associated therewith. Said cartridge contains a supply of hydrogen and is removably fitted to a host device. Prior to use in said host device the user of the host device inputs a UIE into a communications device which, through a network, contacts a secure database with records of authentic UIEs. Said secure database may require verification of the user and/or communication device prior to granting access. The host device also has a communications link whereby one of the database and the communications device may provide authorization to a host device, including but not limited to a controller, to utilize the hydrogen in the canister associated with a specific UIE.

In some exemplary implementations disclosed is a hydrogen cartridge with a dispensing end, said cartridge has a UIE associated therewith. Said cartridge contains hydrogen and is configured to be removably fitted into host device having a controller, a communication link and a communication system or subsystem capable of accepting input of said UIE; connecting said communications system or subsystem to at least one secure database with records of authentic UIEs whereby the communication access the database to verify the UIE; and, wherein said controller is configured to receive verification of UIE via said communication system or subsystem and upon approval hydrogen is allowed to flow from said canister and the fuel cell system and balance of plant of said host device are turned on.

In some exemplary implementations, disclosed is a hydrogen cartridge with a dispensing end, said cartridge associated with a UIE; a host device with an infrastructure having a communication link and a communication system or subsystem capable of accepting user input of said UIE; at least one secure database with records of authentic UIEs; a network whereby the host's communication subsystem can access the database to verify the UIE; and, wherein said controller is configured to receive verification of UIE via said communication subsystem and upon approval hydrogen is allowed to flow from said canister and the fuel cell system and balance of plant of said host device are turned on.

### DRAWINGS

FIG. 1A is a side view of a hydrogen canister

FIG. 1B is a front view of FIG. 1A.

FIG. 2 is a component view of an exemplary implementation of a fuel cell power device which hosts a replaceable hydrogen cartridge.

FIG. 3 is another component view of an exemplary implementation of a fuel cell power device which hosts a replaceable hydrogen cartridge.

FIG. 4 is a flow diagram of an authentication.

FIG. 5 is another component view of an exemplary implementation of a fuel cell power device which hosts a replaceable hydrogen cartridge.

FIG. 6 a partial schematic of major components of a system utilizing replaceable hydrogen cartridges to supply a fuel cell and provide electrical power.

All callouts in the attached figures are hereby incorporated by this reference as if fully set forth herein.

It should be appreciated that, for simplicity and clarity of illustration, elements shown in the figures have not necessarily been drawn to scale. For example, the dimensions of some of the elements are exaggerated, relative to each other, for clarity. Further, where considered appropriate, reference numerals have been repeated among the Figures to indicate corresponding elements. While the specification concludes with claims defining the features of the present disclosure that are regarded as novel, it is believed that the present disclosure's teachings will be better understood from a consideration of the following description in conjunction with the figures and appendix in which like reference numerals are carried forward.

### Further Description

PEM fuel cells require hydrogen fuel to generate electricity. Hydrogen can be stored as-is or can be produced on demand. In certain applications, it is useful to have replaceable hydrogen supplies which may be supplied as pressurized gas in tanks (also known as a container, outer shell, tank, canister or cartridge) or hydrogen stored in metal hydrides, in slurries or in other substrates. Hydrogen may also be supplied in the form of a precursor chemical in the form of a chemical hydride. The latter is particularly suited for portable power system whereby the chemical stored in the tank is reacted using suitable methods, as needed, to produce hydrogen on-demand.

High purity hydrogen is preferred when used in a PEM fuel cell. Purity above 99% is preferred. Hydrogen above about 99.9% purity is more preferred and hydrogen above about 99.99% purity is most preferred. Assuring proper purity of hydrogen is important as impurities in a hydrogen fuel supply may damage or degrade the performance of the PEM fuel cell. Deterring the use of an unauthorized or unauthenticated hydrogen fuel source is one means of insuring that the end user can rely on the stable and production of power from a PEM fuel cell system. This also enables monitoring and disposal of counterfeit hydrogen supplies.

Hydrogen tank fuel supply 10 comprises a body 20 which is a generally hollow element, which may include an outer shell) impermeable to hydrogen leakage a preselected pressure. Said body may be lined or unlined. Said tank has at least one dispensing end 30 which is fitted with a fluid communication means 200 such as a valve, or membrane, frangible barrier and the like.

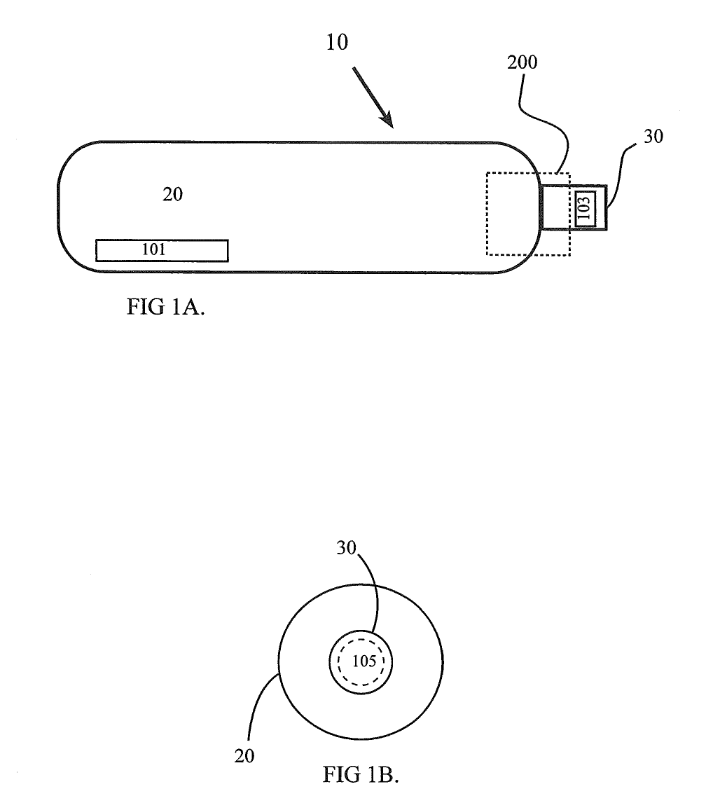

To protect the costly investment of the fuel cell power system or subsystem it is desirable that the supply of hydrogen provided to such a fuel cell system is verified as being pure. Utilizing sensors or gaseous quality monitoring is not always feasible or economically feasible. In lieu of sampling the quality of hydrogen provided in a tank another option is to authenticate the tank and its content via a unique identifier element (UIE) which correlates to at least one of a source of goods, a source of quality control, a source of inspection and a source of the hydrogen. UIEs may be associated with a tank fuel supply in many ways. FIGS. 1A and 1B show a first UIE 101 associated on said body 20 and a second UIE 103 associated with said dispensing end 30. A third UIE 105 is associated with a frangible cover or seal 35 on the end of said dispensing end 30.

The UIE is generally one or more of a code, colors, bar code, numbers, letters, holograms, character, 2D bar code, QR Code (generally described in (ISO/IEC 18004:2000(E)) glyph, image, icon picture, organic chemical, three dimensional (3D) mechanical feature, mechanical strip or matrix, inorganic chemical, doped substrate, natural substrate, manufactured substrate and the like. Chemicals and substrates which may form a base layer of label or tape are a support for a UIE, or such chemicals and substrates may be a UIE.

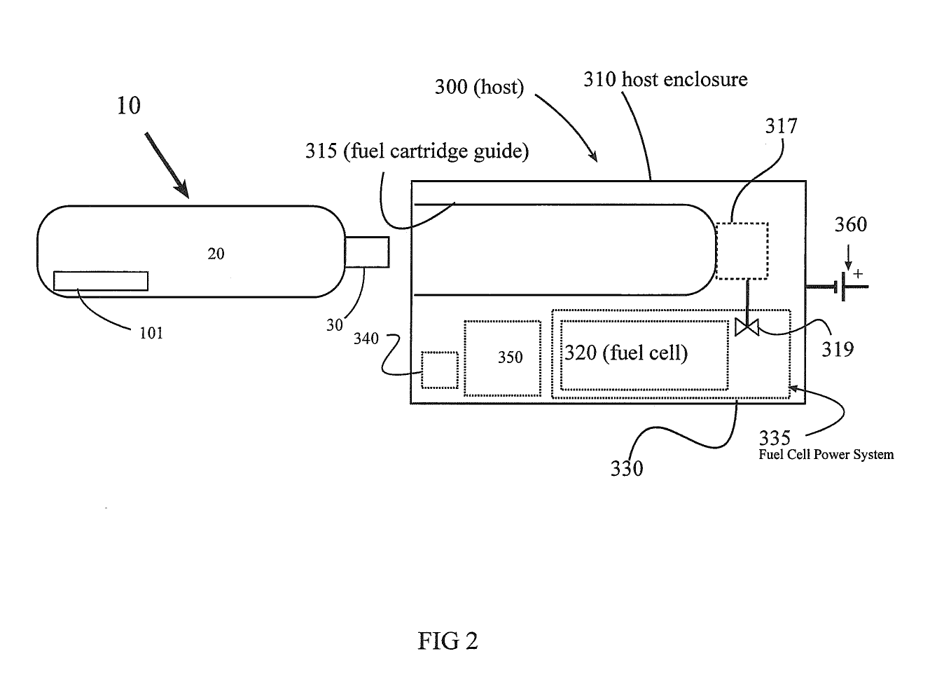

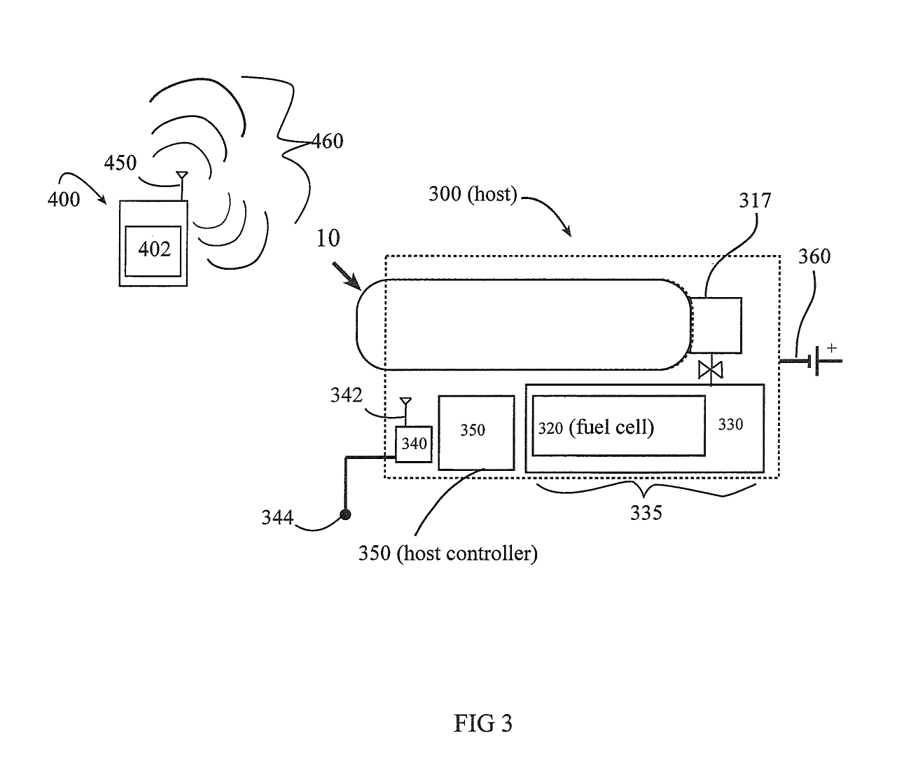

FIGS. 2 and 3 shows a host 300 utilizing replaceable hydrogen tanks (vessels, cartridges, canisters and the like). The host shown in this implementation illustrates aspects of some components and is not intended to be limiting as to the addition or deletion of other components. A host enclosure 310 houses components. A fuel cartridge guide 315 is provided for replaceable tank fuel supply 10. A receiving end mates with and/or accepts a compatible dispensing end 30 of said tank. It may be a keyed interface whereby some combination of shapes, thread pattern and/or orientation may be utilized to provide connection. At least one valve 319 controls hydrogen flow from said tank to the fuel cell stack 320. Said flow may pass through a balance of plant “BOP” 330. A BOP includes one or more of of fan, air filter, valve, H2O collection and heat exchanger (I.e. radiating fins). The fuel cell stack and the BOP form a fuel cell power supply 335 A balance of plant traditionally provides support architecture of the fuel cell stack. Such support may include air filters for the oxygen supply to said fuel cell stack, heat exchangers, cooling, humidification, water collection for water produced from operation, hydrogen leak sensors and shut down associated therewith, fans and pumps to regulate fuel flow. Such balance of plant is known in the art.

In this implementation, a host communication connector 340 provides wired or wireless communication capability with an input device. A host controller is also shown. Said host controller may be one or more microprocessors working as a unit or independently. The host controller manages many functions of the host 200. With respect to tank/fuel authentication said controller communicates with said host communication connector 340 (also called a communications link) which may be wired, wireless, antenna based, USB, wifi, 802.11, blue tooth or other wireless communication protocol and operates to turn on or off the fuel cell power supply system 335 based on at least authentication of a tank. Power output 360 generated by said host is available for use when said host is operational. On/off is linked to allowing the hydrogen fuel to enter the host and fuel cell. Accordingly, the verification may be at the point of use.

In some implementations, wireless device 400 such as an cellular phone, tablet, reader, laptop or other cellular, 802.11, wifi, Bluetooth or RF enabled device has input operation 402 wherein a keypad, touchscreen, scanner, camera, sensor, voice command or the like can be used to enter at least one UIE. Accordingly, input may be via keystroke, optical reader or a combination. Said UIE information is used to confirm or reject authenticity via a database. Said wireless device 400 includes an antenna 450 whereby signals are transmitted and received. In some instance said host device 300 has a communications link 340 capable of receiving communications from a remote wireless communication device 400 wherein the wireless remote communications device also has an input 402 capability and said host can receive a transmission but is not an input device whereby a user can input or scan or otherwise enter UIE information.

As part of, or connected with, said host 300 is a host communication connector 340 (which may be referred to as a communications link) which includes at least circuitry. If said host communication connector 340 is designated for wireless communications it will also include an antenna 342 to receive and or transmit data thus forming a communications system or subsystem. If said host communication connector 340 is designated for wired communications, an I/O plug 344 is provided, whereby an input device may connect to said host communication connector 340. As previously noted, said host communication connector 340 links to said host controller 350, whereby information, instruction, and the like are used to control operational functions of the host 300. With respect to the authentication of replaceable hydrogen fuel containers, said controller can be designated as the gatekeeper to switch on/off the fuel cell power supply system 335. Wireless devices include but are not limited to 802.11, wifi, Bluetooth, cellular, RF, audio, optical. In those cases when host 300 is also the wireless communications device i.e. a cellular phone it can include the wireless device functionality in one unit.

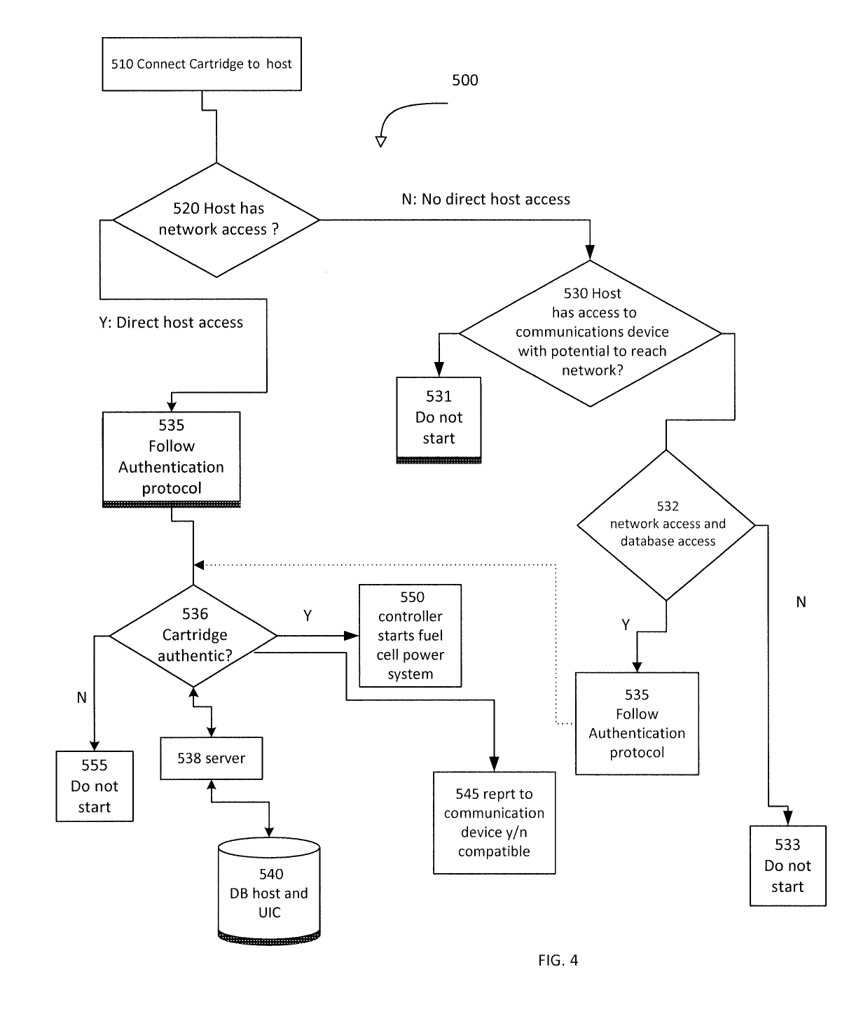

FIG. 4 is a flow diagram 500 showing operation, logic, decision trees, and control aspects of an exemplary system with respect to authentication and use of a replaceable fuel container in a fuel cell power system host device. The host may have integrated communications with servers and databases for this purpose, or the host may use a remote communication device such as a cellphone or the like for all or part of the process.

One aspect of the example is verifying at the point of use the authenticity of the fuel supply and/or fuel supply cartridge.

### Example 1

In this exemplary implementation a series of steps show some aspects of the disclosure:

Step One: (510) is an operation that begins with connection of a container to the host.

Step Two: (520) is a decision of whether the host has network access. If network access query is “no” then:

Step Three (530) is another decision: does host have local connectivity (wired or wireless) to another device which may have (wired or wireless) network capability? If no access to another device then:

Step Four A: (531) and the fuel cartridge cannot be authenticated at that time and the host controller does not start the fuel cell power supply system.

If access to another device is “yes” then:

Step Four B: (532) and make determination if in fact the communication device (400) can access a network to query the database it is directed toward. If “no” access to network or database, then:

Step Five A: (533) and determine that the fuel cartridge cannot be authenticated at that time, and the host controller does not start the fuel cell power supply system. If “yes” network access and yes database access, then:

Step Five B: (535) and the connected device enters an authentication protocol. Devices which can connect to servers or databases for authentication include, but are not limited to, smart phones, 802.11 fobs, tablets, laptops, computers, and the like.

### Example 2

### Communication Host

In this exemplary implementation a series of steps show some aspects of the disclosure:

Step One: (510) is an operation that begins with connection of a container to the host;

Step Two: (520) is a decision of whether the host (300) has network access. If network access query is “yes” then;

Step Three: (535) the network connected device enters an authentication protocol. Devices which can connect to servers or databases for authentication include, but are not limited to, smart phones, 802.11 fobs, tablets, laptops, computers, and the like;

Step Four: (536) is a decisioning step used to determine if cartridge is authentic Communication device contacts at least one of a server (538) and a database (540) to look up UIC associated with cartridge and/or host identity for compatibility. During the process a communication device contacts servers and/or linked databases which may include but are not limited to lists, records and look-up tables of UIEs, hosts and which may also have relational database entries correlating UIE and host compatibility;

Step Five: (Optional) report compatibility or authenticity to communication device (545);

Step Six A: (550) if authentic and/or compatible start system; and,

Step Six B: (550) if not authentic do not start.

### Example 3

### Communication Remote from Host

In this exemplary implementation a series of steps show some aspects of the disclosure:

Step One: (510) is an operation that begins with connection of a container to the host;

Step Two: (520) is a decision of whether the host (300) has network access. If network access query is “no” then;

Step Three: (530) is to determine if there is access to a communications device (400) to attempt to authenticate the fuel cartridge, if “yes” then;

Step Four: (532) wherein it is determined if communications device is able to connect to the network server and or database required to authenticate;

Step Five A: If “No” then (533) do not start flow of hydrogen fuel;

Step Five B: if “Yes” then (535) follow authentication protocol;

Step Six: (536) is a decisioning step wherein the communication device enters the authentication protocol. Communication device contacts at least one of a server (538) and a database (540) wherein the software or application in the communication device looks up the UIC associated with cartridge and/or host identity for compatibility. During the process the communication device contacts servers and/or linked databases which may include but are not limited to lists, records and look-up tables of UIEs, hosts and which may also have relational entries correlating UIE and host compatibility;

Step Seven: (Optional) report compatibility or authenticity to communication device (545);

Step Eight A: (550) if authentic and/or compatible start system; and,

Step Eight B: (555) if not authentic do not start.

In some implementations, the database, in addition to receiving UIE for the tank, also obtains the host device model, make, serial number or its own UIE. In such instances, the database may provide information on tank compatibility with a specific host.

In some instances, an external device (such as a tablet or smart phone) queries the database, and the database responds to the smartphone (device). After responding to the smart phone (device) the user may visually or audially receive an authentication approval.

In some instances, an external device (such as a tablet or smart phone) queries the database, and the database can respond to the host (in those instances when the host has a communications connection and controller).

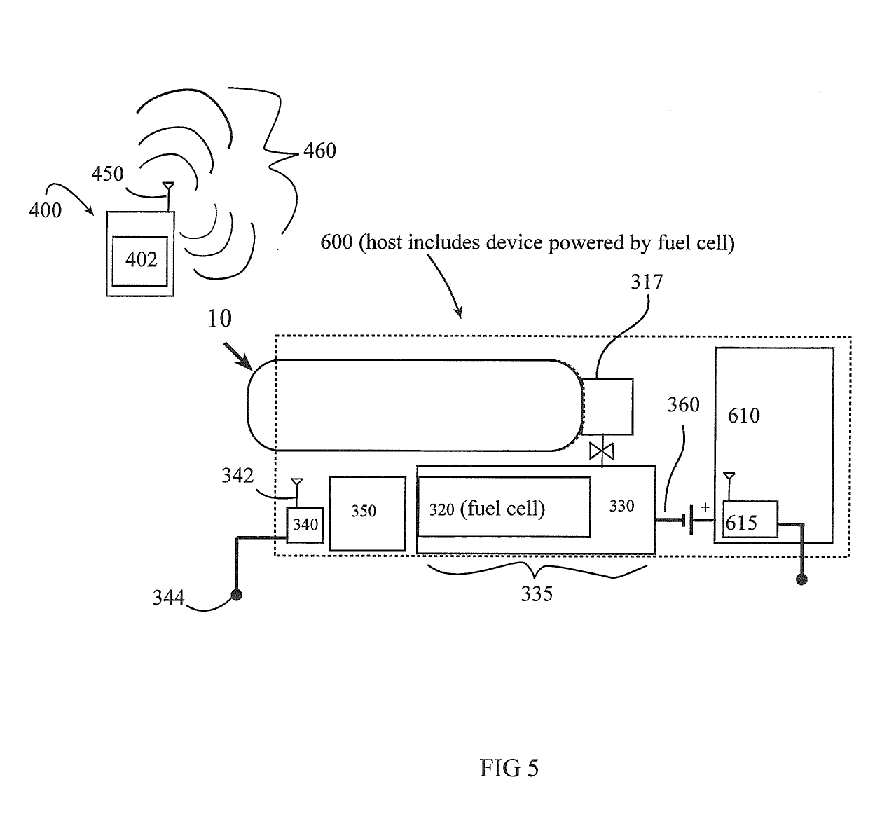

FIG. 5 shows a smart host 600 which is a unitary fuel cell power system, and device 610 which utilize electricity from said fuel cell power system. A non-exclusive list of devices includes PDA, monitor, phone, tablet, mouse and the like. Those of ordinary skill in the art will recognize that a plethora of devices may be powered by the fuel cell power supply, including but not limited to cellular phones, gaming systems, computer peripherals, medical devices, pumps, tablets, laptops, monitors, and displays.

Smart host 600 may also contain processors and controller within device 610. In some instances, it may be advantageous to leverage the existing device 610 infrastructure 615 of processors and/or controllers and the like within the device to eliminate or reduce redundant components. In other instances redundant components may be preferred. The infrastructure 615 of device 610 may include one or more of a microprocessor, a battery, an input devices, a touch screen, a controller, an antenna, cellular communications hardware and software, wired communications hardware and software, local wifi, 802.11 or Bluetooth hardware and software.

In some instances, for example, a tablet computer or cellular phone the device 610 and its infrastructure 615 may be primary to host controller 350.

In some instances, for example, a tablet computer or cellular phone the device 610 and its infrastructure 615 replace host controller 350.

In some instances, for example, a tablet computer or cellular phone the device 610 and its infrastructure 615 may be secondary to and work host controller 350.

The disclosure encompasses devices and systems that require authorization inputted by the user. What is also encompassed is a device or system that excludes and does not use an authorization arising from interactions between only the cartridge and host device.

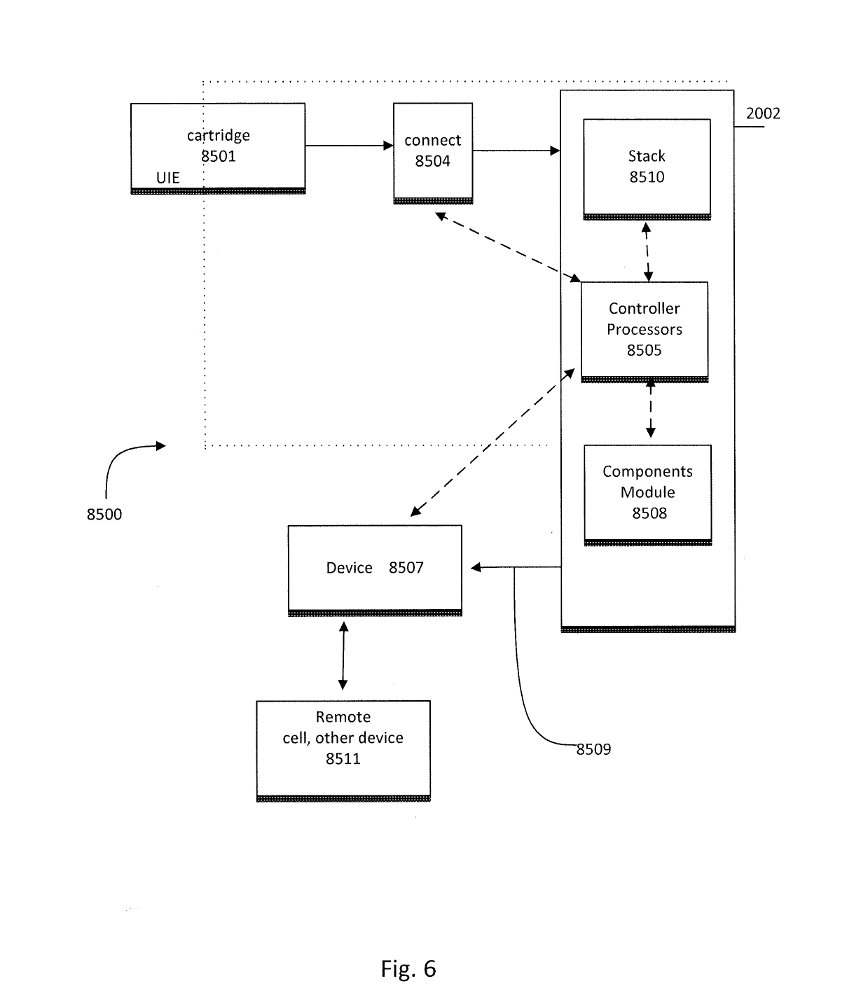

FIG. 6 shows an overview of some major components of a schematic of a fuel cell power system 8500 utilizing replaceable hydrogen fuel supply canisters 8501 with a host 8502. A canister 8501 having a cartridge filled with hydrogen and having a pressure relief valve is connected via a fluid communication means to a gas delivery 8504 component also known as a host fluid communication means. A controller 8505 can be used to control the flow of hydrogen from the canister to the host via the host fluid communication means. Said controller may also be used to communicate with any attached electronic device 8507 utilizing power from said system. Said controller may also interact with processor and logic in the electronics module 8508 regarding optimizing parameters of the system. Electricity is supplied 8509 to the device. Wherein at least one of said controller and electronics adjust the consumption of hydrogen at the fuel cell 8510. A remote communications device such as a cell phone or smart tablet or the like 8511 can interact with the device 8507 and/or the host.

While the method and devices have been described in terms of what are presently considered to be the most practical, it is to be understood that the disclosure need not be limited to the disclosed implementations. It is intended to cover various modifications and similar arrangements included within the spirit and scope of the claims, the scope of which should be accorded the broadest interpretation so as to encompass all such modifications and similar structures. The present disclosure also includes any and all implementations of the following claims.

It should also be understood that a variety of changes may be made without departing from the essence of the disclosure. Such changes are also implicitly included in the description. They still fall within the scope of this disclosure. It should be understood that this disclosure is intended to yield a patent covering numerous aspects of the invention both independently and as an overall system and in both method and apparatus modes.

Further, each of the various elements of the disclosure and claims may also be achieved in a variety of manners. This disclosure should be understood to encompass each such variation, be it a variation of an implementation of any apparatus implementations, a method or process implementations, or even merely a variation of any element of these.

Particularly, it should be understood that as the disclosure relates to elements of the invention, the words for each element may be expressed by equivalent apparatus terms or method terms—even if only the function or result is the same.

Such equivalent, broader, or even more generic terms should be considered to be encompassed in the description of each element or action. Such terms can be substituted where desired to make explicit the implicitly broad coverage to which this invention is entitled.

It should be understood that all actions may be expressed as a means for taking that action or as an element which causes that action.

Similarly, each physical element, disclosed, should be understood to encompass a disclosure of the action which that physical element facilitates.

Any patents, publications, or other references, mentioned in this application, for patent, are hereby incorporated by reference. In addition, as to each term used, it should be understood that, unless its utilization in this application is inconsistent with such interpretation, common dictionary definitions should be understood, as incorporated, for each term, and all definitions, alternative terms, and synonyms such as contained in at least one of a standard technical dictionary recognized by artisans and the Random House Webster's Unabridged Dictionary, latest edition, are hereby incorporated by reference.

Finally, all references, listed in the Information Disclosure Statement or other information statement filed with the application, are hereby appended and hereby incorporated by reference; however, as to each of the above, to the extent that such information or statements incorporated by reference might be considered inconsistent with the patenting of this/these invention(s), such statements are expressly not to be considered as made by the applicant(s).

In this regard, it should be understood that, for practical reasons, and so as to avoid adding potentially hundreds of claims, the applicant has presented claims with initial dependencies only.

Support should be understood to exist, to the degree required under new matter laws,—including but not limited to United States Patent Law 35 USC 132 or other such laws,—to permit the addition of any of the various dependencies or other elements presented under one independent claim or concept as dependencies or elements under any other independent claim or concept.

To the extent that insubstantial substitutes are made, to the extent that the applicant did not in fact draft any claim so as to literally encompass any particular exemplary implementations, and to the extent otherwise applicable, the applicant should not be understood to have in any way intended to or actually relinquished such coverage as the applicant simply may not have been able to anticipate all eventualities; one skilled in the art, should not be reasonably expected to have drafted a claim that would have literally encompassed such alternative exemplary implementations.

Further, the use of the transitional phrase “comprising” is used to maintain the “open-end” claims herein, according to traditional claim interpretation. Thus, unless the context requires otherwise, it should be understood that the term “comprise” or variations such as “comprises” or “comprising”, are intended to imply the inclusion of a stated element or step or group of elements or steps but not the exclusion of any other element or step or group of elements or steps.

Such terms should be interpreted in their most expansive forms so as to afford the applicant the broadest coverage legally permissible.

1. A method of verifying at the point of use, a hydrogen fuel canister, the method comprising:
associating at least one unique identifier element (UIE) (101) with a fuel canister (20);
inputting (402) the UIE into a communication device (400);
querying, via the communication device, at least one of a sever (538) and a database (540) to determine if the canister associated with the UTE is authentic; and,
reporting result of query to a communication device (545).

2. The method of claim 1, the method further comprising one of the communication device and the communications link (340) providing authorization for a host device controller (350) to utilize the canister associated with the UIE (550).

3. The method of claim 1, the method further comprising:
Inputting the identify of a host device in which said canister is intended for use in to the communications device;
querying a database to determine if the canister associated with said UIE is compatible for use with the host device; and,
reporting if said associated canister is compatible with said host device to said communication device (545).

4. The method of claim 1 wherein the host device is the communication device and is input with its own identity further comprising the host operating as the communication.

5. The method of claim 1 wherein the database is remote from the host device.

6. The method of claim 5 wherein the database is accessed through a network.

7. The method of claim 6 wherein the network is one of a cellular network and the interne.

8. The method of claim 1 wherein the communications device is at least one of a smartphone, smart device, pad, tablet, laptop, and computer.

9. The method of claim 8, the method further comprising a host communication connection wherein said host is also a communication device and said communication device acts as a switch to authorize said host to utilize said fuel canister.

10. The method of claim 9 wherein authentication by said communication device of a host device is reported to a database to record the authorization and use of the fuel canister.

11. The method of claim 1 wherein the UIE is selected from the group considering of codes, colors, bar code, numbers, letters, holograms, character, 2D bar code, QR Code, glyph, image, icon picture, organic chemical, 3D mechanical feature, mechanical strip or matrix, inorganic chemical, doped substrate, natural substrate, and manufactured substrate.

12. The method of claim 8 wherein inputting is via keystrokes, scan, touch screen, optical imaging or voice command.

13. The method of claim 8, the method further comprising a communications link (340) in said host device which may receive authorization from a server in response to the database query.

14. (canceled)

15. A hydrogen fuel authentication system, comprising:
a hydrogen cartridge with a dispensing end, said cartridge associated with an UIE;
a host device with a controller, a communication subsystem capable of accepting input of said UIE;
at least one secure database with records of authentic UIEs;
a network whereby the communication subsystem can query the database to verify the UIE; and,
wherein said controller is configured to receive verification of UIE via said communication subsystem and upon verification the controller allows hydrogen to flow from said canister and the fuel cell system and balance of plant of said host device are turned on.

16. A hydrogen fuel authentication system, comprising:
a hydrogen cartridge with a dispensing end, said cartridge associated with an UIE;
a host device with an infrastructure having a communication link (340) capable of receiving transmission from a wireless remote communication device (400);
at least one secure database (540) with records of authentic UIEs;
a network whereby a wireless remote communications device with credentials can query the database to verify the UIE; and,
wherein said communications link is configured to receive verification of UIE via one of the wireless remote communications device and a remote server and upon verification the host controller allows hydrogen to flow from said canister and the fuel cell system and balance of plant of said host device are turned on.
